(19) United States
(12) Patent Application Publication
(10) Pub. No.: US 2016/0140250 A1
(43) Pub. Date: May 19, 2016

(54) DYNAMIC ADJUSTMENT OF ELEMENTS OF A DOCUMENT

(71) Applicant: Microsoft Technology Licensing, LLC., Redmond, WA (US)

(72) Inventors: Hai WANG, Redmond, WA (US); Radoslav P. Nickolov, Seattle, WA (US)

(21) Appl. No.: 14/541,008

(22) Filed: Nov. 13, 2014

(51) Int. Cl. G06F 17/30; G06F 17/21

(52) U.S. Cl. CPC G06F 17/30905; G06F 17/212; G06F 17/30896

(57) ABSTRACT

Technologies are described herein for providing dynamic adjustment of elements of a document. A document having code defining an element is received and rendered at a first rendering scale. One or more techniques are used to determine if a dimension of the element is greater than a dimension of a display area. If the dimension of the element is greater than the dimension of the display area, a second rendering scale is determined based on the dimension of the display area. The second rendering scale is then applied to the element by wrapping the element in a container. The element is then scaled based on the second rendering scale. In some configurations, a negative margin-bottom is applied to other content of the document to reposition the other content of the document relative to the positon of the element.

### BACKGROUND

The evolution of web page development has benefited programmers, designers and end users with many useful features. Although there have been many improvements in the way content is created, shared and displayed, there is still a need to improve the way some data is formatted. For instance, when rendering hypertext markup language (“HTML”) table elements in a multi-column web browser mode, some table elements may not be properly displayed, e.g., cut or truncated by the edge of a display area, because tables may be configured with a hard-coded minimal width that may exceed the boundaries of the display area. This particular issue is becoming more common with the introduction of mobile devices, which have smaller display screens than desktop computers. In addition, other document parameters limiting a display area may obstruct the display of one or more table elements or other content.

It is with respect to these and other considerations that the disclosure made herein is presented.

### SUMMARY

Technologies are described herein for providing dynamic adjustment of elements of a document. In some configurations, techniques disclosed herein may receive a document having code defining at least one element, such as a table. The document is rendered at a first rendering scale. One or more techniques are used to determine if at least one dimension, e.g., the width or height, of the rendered element is greater than at least one dimension of a display area. The dimension of the display area may be defined by the document, e.g., a width of a column containing the element; or the dimension of display area may be defined by other parameters, such as a number of pixels of a display device.

If the at least one dimension of the element is greater than the at least one dimension of the display area, a second rendering scale is determined based on at least one dimension of the display area and/or at least one dimension of the element. The second rendering scale is then applied to the element by wrapping the element in a container. The element is then scaled based on the second rendering scale. In some configurations, the techniques disclosed herein involve the application of an adjustment to other content of the document, e.g., a negative margin-bottom, to modify the spacing between the element and the other content.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing several example components of a system for providing dynamic adjustment of elements of a document.

FIG. 2 is a flow diagram illustrating aspects of a method for providing dynamic adjustment of elements of a document.

FIG. 3 illustrates an example of rendered content that is modified by techniques described herein.

FIG. 4 illustrates an example of the rendered content having an element scaled independently from other elements of a document.

FIG. 5 illustrates an example of the rendered content having a scaled element and other elements that are adjusted using a negative margin-bottom.

FIG. 6 illustrates an example rendering of another document containing a table.

FIG. 7 illustrates a resulting display of an output that is generated by applying techniques described herein to the document rendered in FIG. 6.

FIG. 8 is a computer architecture diagram illustrating an illustrative computer hardware and software architecture for a computing system capable of implementing aspects of the techniques and technologies presented herein.

FIG. 9 is a diagram illustrating a distributed computing environment capable of implementing aspects of the techniques and technologies presented herein.

FIG. 10 is a computer architecture diagram illustrating a computing device architecture for a computing device capable of implementing aspects of the techniques and technologies presented herein.

### DETAILED DESCRIPTION

The following detailed description is directed to concepts and technologies for providing dynamic adjustment of elements of a document. In some configurations, technologies herein provide dynamic adjustment of multi-column tables. A program module may receive a document having code defining a table. The document is then rendered at a first rendering scale. One or more techniques are used to determine if the width of the rendered table is greater than the width of a display area containing the table. The width of a display area may be defined by parameters associated with an element of a document, e.g., a column width; or the width of a display area may be limited by other parameters, such as a number of pixels of a display device. If the width of the table is greater than the width of the display area, a second rendering scale is determined based on the width of the display area and the width of the table. The second rendering scale is then applied to the document by wrapping the table to contain the second rendering scale to the table. The table is then scaled based on the second rendering scale. In some configurations, the techniques disclosed herein involve the application of a negative margin-bottom to mitigate the existence of undesirable margins created by the application of the second rendering scale.

While the subject matter described herein is presented in the general context of techniques for analyzing and adjusting a width of a table, it can be appreciated that the techniques described herein may apply to any dimension of any type of object, such as an image, text or any other data structure. It can be appreciated that techniques for processing and adjusting a negative margin-bottom may also apply to any technique for adjusting a position of any type of object or content.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

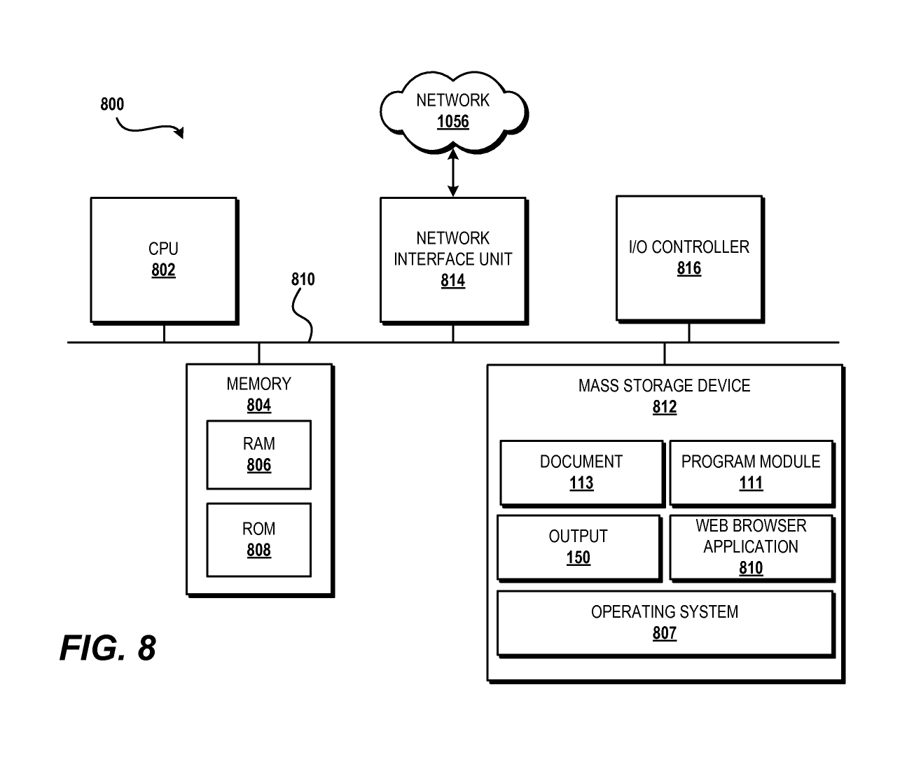

In the following detailed description, references are made to the accompanying drawings that form a part hereof, and in which are shown by way of illustration specific configurations or examples. Referring now to the drawings, in which like numerals represent like elements throughout the several figures, aspects of a computing system, computer-readable storage medium, and computer-implemented methodologies for providing dynamic adjustment of elements of a document. As will be described in more detail below with respect to FIGS. 8-10, there are a number of applications and services that can embody the functionality and techniques described herein.

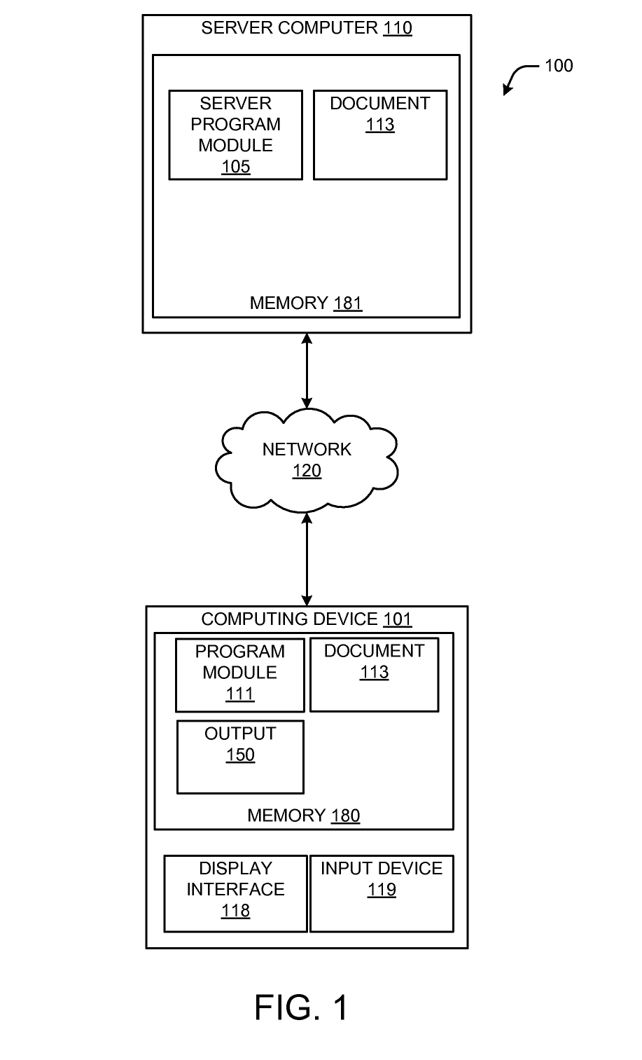

FIG. 1 is a system diagram showing aspects of one illustrative mechanism disclosed herein for providing dynamic adjustment of elements of a document. As shown in FIG. 1, a system 100 may include a computing device 101, a server computer 110 and a network 120. In some configurations, the computing device 101 and the server computer 110 may operate as stand-alone devices. In such configurations, the computing device 101 and the server computer 110 may each be configured to perform the techniques described herein. In addition, the server computer 110 and the computing device 101 may be interconnected through one or more local and/or wide area networks, such as the network 120. In such configurations, the computing device 101, the server computer 110 and/or other computing devices may be configured to operate in concert to perform the techniques described herein. It should be appreciated that many more network connections may be utilized than illustrated in FIG. 1.

It can be appreciated that the server computer 110 may be any type of computing device, such as a personal computer, a server or a number of computing devices configured to perform aspects of the techniques described herein. The server computer 110 may include memory 180 for storing a server program module 105 that is configured to process or generate the document 113. It can be appreciated that the server program module 105 may be configured to process, generate and distribute documents, such as document 113, to one or more client computers, such as the computing device 101. The server program module 105 may be a server application such as an APACHE HTTP SERVER or any other program configured to generate, process and/or deliver documents to one or more computers.

The computing device 101 may be any type of computing device, such as a mobile phone, a tablet computer, a server, a laptop computer, a combination of computers or a desktop computer. The computing device 101 may include a display interface 118 for displaying rendered data and an input device 119 for receiving input from a user. The display interface 118 may be a touch-sensitive display screen that is operable to display images and/or video data, and also operable to receive input from the user, input that may involve a touch signal that indicates an input gesture. The computing device 101 may also include memory 180 storing a document 113 and a program module 111.

The computing device 101 may operate as stand-alone device. Thus, the program module 111 of the computing device 101 may be configured to process the techniques described herein. For instance, the program module 111 may be configured to receive, generate and/or render the document 113, which may be in the form of a mark-up document. As will be described in more detail below, the program module 111 may also be configured to determine the width of a table of a rendered document and the width of a display area. If one or more conditions are met, the program module 111 may determine a rendering scale to be applied to the table. The program module 111 may also be configured to generate the output 150 that applies to the rendering scale to the table. In addition, the program module 111 may be configured to render and display the document 113 and/or the output 150 on the display interface 118.

In some configurations, the computing device 101 may operate in conjunction with the server computer 110 to perform the techniques disclosed herein. For instance, the server computer 110 may generate and/or store a document 113 having at least one table. The document 113 may be communicated from the server computer 110 to the computing device 101 where it is processed by the program module 111 to determine if at least one table of the document 113 has a width that is greater than the width of a display area, such as a display area defined by parameters of the document or a display area that is limited by the capabilities of the display interface 118. If it is determined that at least one table has a width that is greater than the width of the display area, techniques herein generate an output 150 that applies a rendering scale to the table. As will be described in more detail below, the rendering scale allows the table to fit in the display area. In addition, the output may include the application of a negative margin-bottom to remove a margin created by application of the rendering scale. In some configurations, code may be combined with code or parameters of the document to move, scale or arrange data.

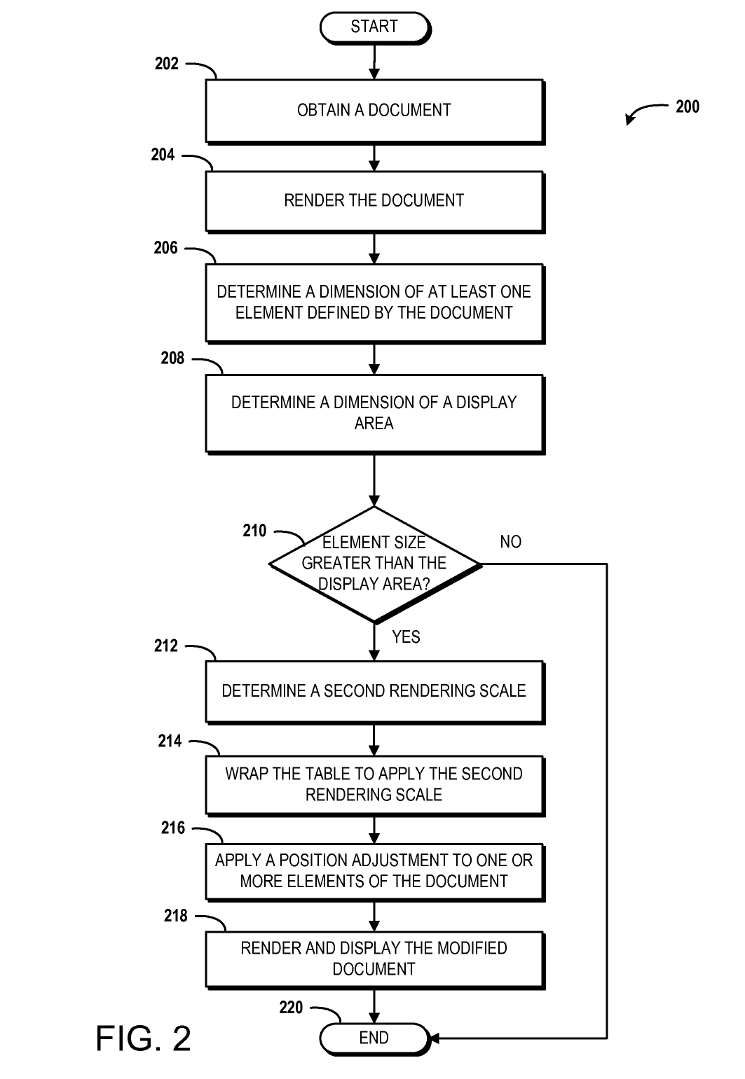

Turning now to FIG. 2, aspects of a routine 200 for providing dynamic adjustment of elements of a document are shown and described below. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can be ended at any time and need not be performed in its entirety. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof

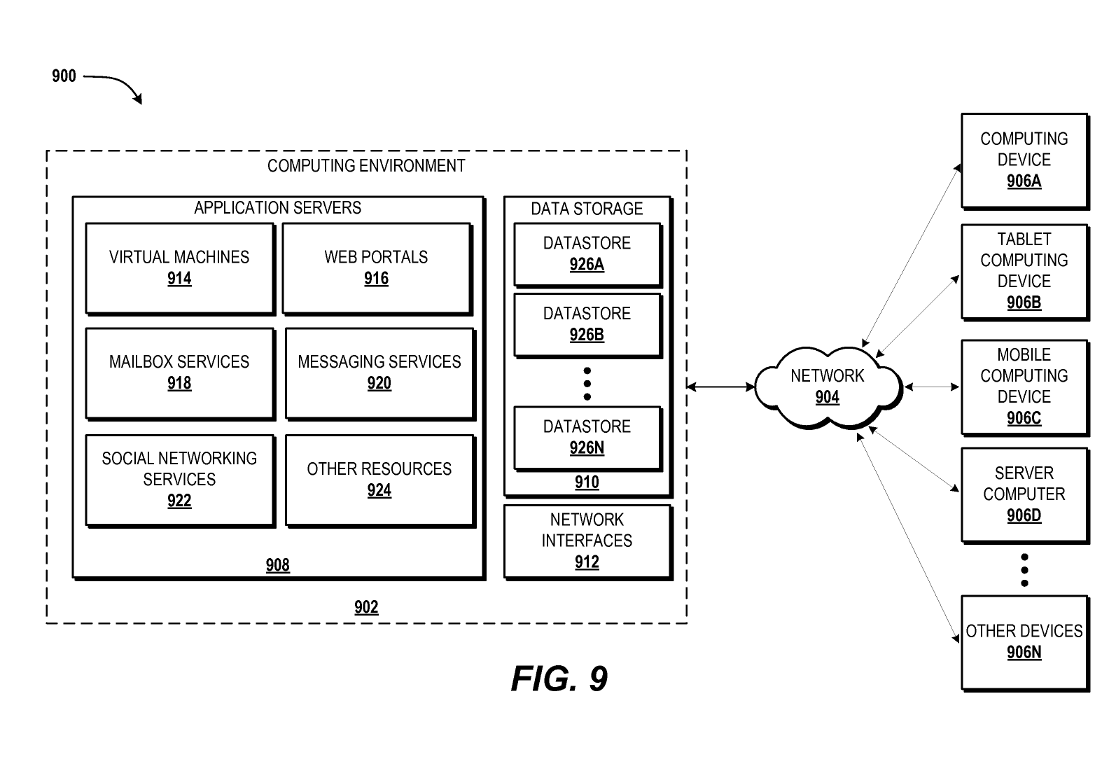

As will be described in more detail below, in conjunction with FIGS. 8-10, the operations of the routine 200 are described herein as being implemented, at least in part, by an application, such as the program module 111. Although the following illustration refers to the program module 111, it can be appreciated that the operations of the routine 200 may be also implemented in many other ways. For example, the routine 200 may be implemented, at least in part, by the use of a web browser 810 or any other application configured to perform the techniques described herein. In addition, one or more of the operations of the routine 200 may alternatively or additionally be implemented, at least in part, by the web browser application 810 working in conjunction with other software modules, such as the one or more application servers 908 of FIG. 9.

With reference to FIG. 2, the routine 200 begins at operation 202, where the program module 111 obtains a document 113. As can be appreciated, the document 113 may be received or generated by the program module 111. For example, in some configurations, the document 113 may be generated and/or stored by the server program module 105. The server program module 105 may communicate the document 113 to the program module 111 of the computing device 101 via the network 120. In other configurations, the document 113 may also be generated and/or stored by the computing device 101.

As can be appreciated, the document 113 may include code that defines at least one object or data structure, such as a table. In configurations where the document 113 includes a table, the document may define an arrangement of rows and columns for any content, such as text, images, etc. As can be appreciated, there are a number of ways to define a table, such as the user of the <table>tag. As can be appreciated, in some configurations, any code defining the table may define a width of the table as well as a width of at least one column of the table. Any code defining the table may define a height of the table as well as a height of at least one column of the table. Such code is known and the details of such code is not provided herein.

Although the samples provided herein involve a multi-column structure, such as a table, it can be appreciated that the scope of the present disclosure may process, analyze and modify any structure, command, data or code that may be used to define any arrangement of content. It can also be appreciated that the document 113 may define a display area having a fixed width, such as a column configured with a maximum width. A table or another data structure embedded within the display area having the fixed width may create a conflict where the content of the table or other content of the document may be obscured. Techniques described below may be utilized to mitigate or eliminate such conflicts.

Next, at operation 204, the program module 111 renders the document 113. In some configurations, the program module 111 performs one or more rendering functions to calculate a display position for each of the elements defined in the document 113. For illustrative purposes, an element defined by the document 113 may include any data structure, such as an image, table or text. Data or parameters in document 113 may define a size, shape, characteristic or display property of each element. Any known rendering technique may be used in operation 204 and such techniques are known in the industry and are thus not described in detail herein.

As can be appreciated, the rendering of the document 113 may not require the display of the document 113 on a display device, as the rendering may generate an interim model stored in the memory 180 of the computing device 101 for analysis. As can also be appreciated, a rendering scale (also referred to herein as a “first rendering scale”) may be used to render the document 113. As can be appreciated, the rendering scale may determine the size in which the elements of the document 113 are rendered. The first rendering scale may be a default setting of the program module 111 or the first rending scale may be obtained from a setting or an input, which may include an input received by a user. Once the document 113 is rendered, the position of one or more document elements, e.g., tables and content within the tables, may be analyzed.

Next, at operation 206, the program module 111 analyzes the rendered document to determine a dimension of at least one element defined in the document 113. Any number of known techniques for determining the dimension of a rendered element may be used in operation 206. For instance, the program module 111 may examine the pixels of the rendered output of operation 204 and determine the number of pixels from one edge of the element to the right edge of the element. As described below, in another example, queries to one or more browser functions may be used to retrieve coordinates of an element, such as a table. Such coordinates may be used to determine a dimension, such as a width, of at least one element. In yet another example, the document 113 may be analyzed to determine a dimension of at least one element. For example, a document 113 may specify that a table having a width of a particular number of pixels.

In one illustrative example of operation 206, the document 113 may define a table. The program module 111 may analyze the rendered document to determine the width of the table by the use of any known technique. For instance, some rendering tools, which may be component of a browser, provide coordinate boundaries for the rendered table. The coordinate boundaries generated by such rendering tools, may provide coordinates for a number of edges or corners of the table, and such coordinates may be used to determine a width or height. Although these examples illustrate methods that involve an analysis of the pixels or function calls to obtain coordinates, other techniques for measuring a dimension, such as a width, of an element may be used in operation 206.

Next, in operation 208, the program module 111 may determine one or more dimensions of the display area. As summarized above, in some configurations, a dimension of a display area may be defined by parameters associated with an element of a document. For example, if a document defines a table that is arranged within a column having a fixed width, the display area of the table is limited by the width of the column. Calls to one or more rendering tools may be made to retrieve boundary coordinates of the column. Such coordinates may be analyzed to determine the width of the column, e.g., the width of the display area. Any known technique for analyzing a document to determine one or more dimensions of the display area may be used in operation 208.

In other configurations, a dimension of a display area may be limited by parameters associated with the capabilities of a display device, such as the display interface 118. For instance, the width of a display area may be limited by a number of pixels of the display device. Any known technique for obtaining data describing the capabilities of a display device, such as a display width, may be used in operation 208. For instance, calls to one or more interfaces may be used to obtain the resolution of a display device. It can be appreciated that any known method for obtaining data defining a display area may be used in operation 208. As will be described below, techniques described herein may analyze the width of the table and the width of the display area to determine if adjustments to the document rendering are needed.

Next, at operation 210, the program module 111 determines if the size of the element is greater the size of the display area. In some configurations, the program module 111 may determine if at least one dimension of the element is greater than a corresponding dimension of the display area. For instance, with reference to the above-described example, operation 210 may process the document 113 defining a table to determine if the width of the table is greater than the width of the display area. As described above, the width of an element, such as a table, may be defined in terms of a number of pixels. Such parameters may be included in the document 113 as part of the table parameters, such as a table width parameter. Data defining the width of the display area, which may also be measured in terms of a number of pixels, may be obtained by the use of a query to a hardware component or a software module storing one or more specifications of the display interface 118. In such an example, in operation 210, the number of pixels associated with the width of the table may be compared with the number of pixels defining the width of the display area without the need to render the document.

Other techniques for comparing one or more dimensions of an object, such as the width of a table, against one or more dimensions of a display area, such as width of a display area, are also within the scope of the present disclosure. For example, the system 100 may obtain the width of a table by querying data from a rendering module. Such data may be compared against any data defining a dimension of a display area.

At operation 210, if it is determined that the width of the element, e.g., the table, is not greater than the width of the display area, e.g., width of the display interface 118, the routine 200 proceeds to operation 220 wherein the routine 200 terminates. However, at operation 208, if it is determined that the width of the element, e.g., the table, is greater than the width of the display area, the routine 200 proceeds to operation 212 where the program module 111 determines a second rendering scale.

In operation 212, the program module 111 determines a rendering scale for the element. Generally described, operation 210 involves a process for determining a rendering scale that will be used to resize the element to allow the element to fit within the display area. With reference to the example involving the table, the program module 111 may determine a desired width for the table that allows the entire table to fit within the display area. Then, using the desired table width and the original width of the rendered table, a rendering scale may be determined.

For illustrative purposes, the rendering scale generated in operation 212 is also referred to herein as the “second rendering scale.” The second rendering scale may be determined by the use of a number of different techniques. In one example, the second rendering scale may be determined by dividing the width of the display area by the width of the rendered table. In one specific example, if the table is 500 pixels wide and a display screen of a device is only 380 pixels wide, the second rendering scale may be 380/500=0.76. As will be described below, the second rendering scale may be used by the program module 111 to scale the size of the table thus allowing a rending of the table to fit within the display area.

Next, at operation 214, the program module 111 may wrap the element, such as the table, to apply the second rendering scale to the element. Operation 214 may be performed using a number of different techniques. In general, operation 214 may involve any process that isolates the table, or any other element of the document 113, from other elements of the document 113. For instance, a container may be configured to apply the second rendering scale to the element, e.g., the table, without impacting the scale of other elements of the document 113. In some configurations, code may be added or applied to the document 113 to wrap the table. In one illustrative example, HTML <div> elements may be utilized to create one or more wrappers. TABLE 1 illustrates an illustrative example of how a wrapper (also referred to herein as a “container”) may be created around a table.

TABLE 1

```
<div style = transform: scale (0.76)>
  <table>
  </table>
</div>
```

These examples are provided for illustrative purposes and are not to be construed as limiting, as it can be appreciated that the techniques described herein may be applied to many other data types other than tables. In addition, the techniques disclosed herein may involve the use of any other code that creates a wrapper capable of applying a rendering scale to select elements of a document while providing a form of separation that allows other elements of the document to be rendered at another rendering scale.

Next, at operation 216, the program module 111 applies a position adjustment to one or more elements of the document 113. Generally described, the document 113 may include other content around the element. In operation 214, when the second rendering scale is applied to the element, the content around the element may be obscured. For example, a margin between the element and the other content may be enlarged, or the other content may be out of position such that the appearance or layout of the document 113 does not convey the author's intent. To mitigate the potential issues created by these margins, one or more position adjustments, such as the introduction of a negative margin-bottom, may be applied to the other content of the document 113.

For illustrative purposes, the other content of the document 113 is also referred to herein as “other elements” of the document 113. In some configurations of operation 216, one or more formatting and/or layout parameters may be adjusted to change the position or another property of the other elements of the document 113. For example, in operation 214, if the element is scaled down to half of its original height, this modification may create a gap between the element and text positioned below the element. To compensate for the gap, operation 216 may apply a “margin” adjustment to the document to move the text closer to the element. In another example, if the document 113 was arranged to have text to the right of the element, one or more layout parameters may be applied to the document to reposition the text to the right of the element to restore the author's intent.

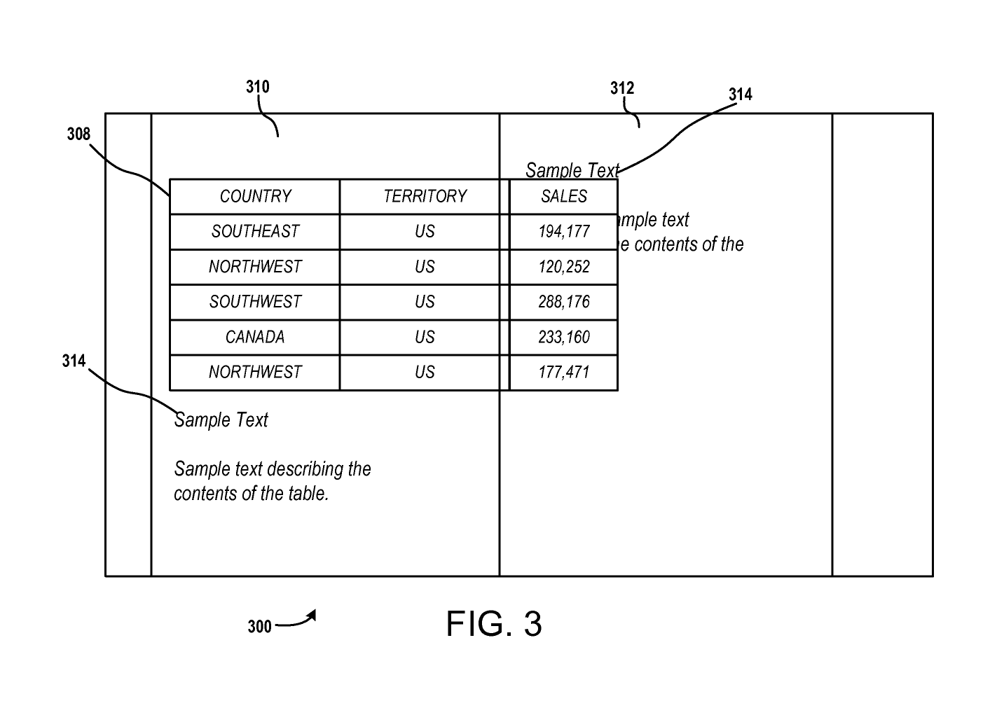

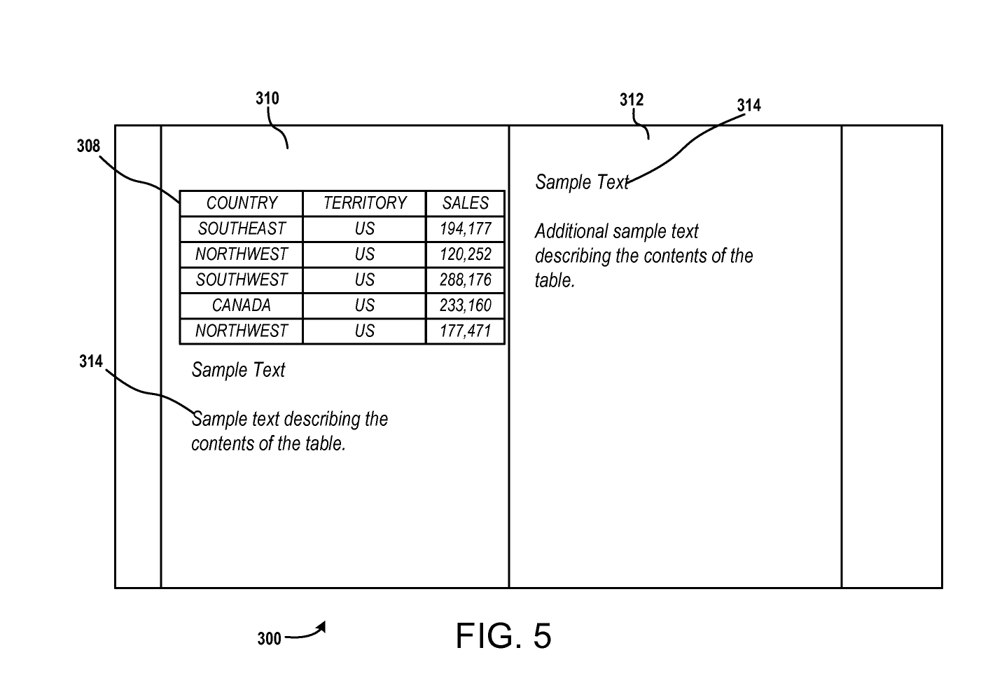

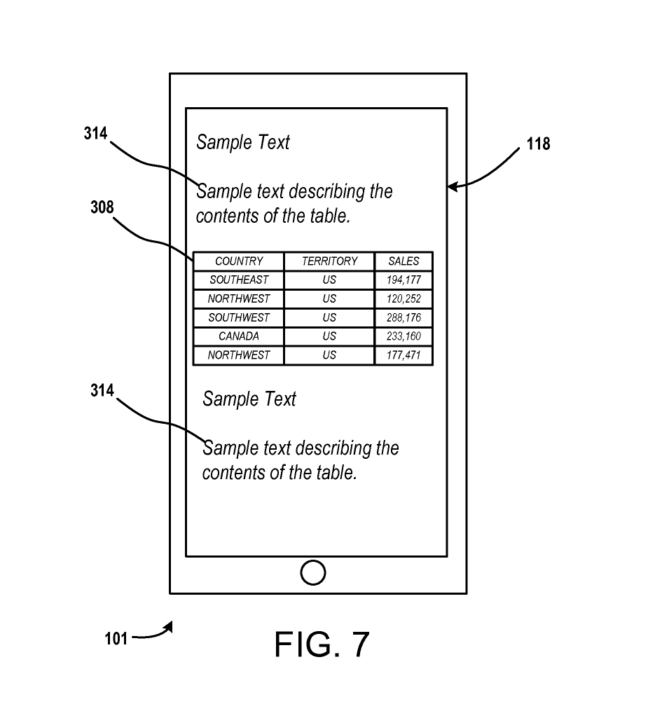

In yet other aspects of operation 216, the element that was scaled in operation 214 may also be repositioned. For instance, if a table is scaled down in operation 214, the table may not be in a position that conveys the author's original intent, e.g., the table may be too close to the edge of a viewing boundary or too close to another element. In operation 216, any modification may be applied to the document 113 to adjust the position of the element and/or the other elements. It can be appreciated that these examples are provided for illustrative purposes only and they are not to be construed as limiting. Aspects and additional details of operation 216 are described in more detail below and shown in FIGS. 3-5. As will be described in more detail below, operation 214 and operation 216 may introduce modifications, e.g., the introduction of a second rendering scale and a margin adjustment, to the document 113 to generate a modified document, also referred to herein as an “output 150.” Examples of such an output 150 are described in more detail below and shown in FIG. 5 and FIG. 7.

Next, the routine 200 continues at operation 218 where the program module 111 renders and displays the output 150. As can be appreciated, the rendering and the display of the output 150 may be processed by any software module, such as a browser or other program capable of rendering a document. After operation 218, the routine 200 terminates at operation 220.

FIG. 3 illustrates an example of rendered content 300 that may be generated in operation 204. In this illustrative example, the rendered content 300 may be generated from a document 113 defining a first column 310, a second column 312, a table 308 and text 314. In addition, the document 113 provides parameters for the position of the table 308, which in this illustrative example, the upper left-hand cell of the table 308 is arranged within the first column 310.

As summarized above, a document 113 may define one or more parameters for the display area. For instance, the first column 310 may include parameters that may define a minimum width or a fixed width. In addition, the document 113 may also have one or more parameters for the table 308, including parameters that may define a fixed width. As can be appreciated, the introduction of such parameters may cause one or more conflicts between the elements of the document. For instance, as shown in FIG. 3, it is a given in this example that the width of the table 308 is greater than the width of the first column 310. In such an arrangement, the table 308 obscures other content, such as the text 314 arranged in the second column 312.

The example depicted in FIG. 3 is just one example of how a dimension of a table may create a conflict with one or more dimensions of a display area, e.g., the first column 310. It can be appreciated many other dimensions and/or parameters of the table 308, or any other element, may have a conflict with a boundary of a display area or other content. As described below, by applying techniques described herein to one or more parameters of the document 113, adjustments may be made to the table 308, such that the table 308 may be scaled using a rending scale, while other elements of the document 113, e.g., the text 314 and the first column 310 and the second column 312, are not impacted by the rending scale.

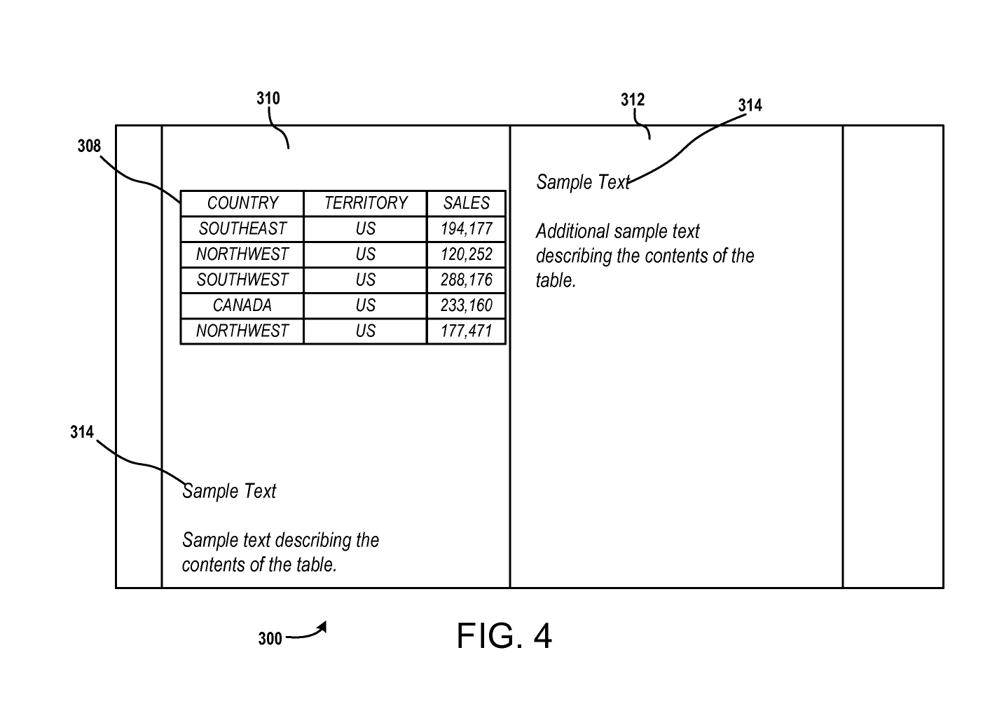

FIG. 4 illustrates another example of the rendered content 300 that may be generated when operations 204-214 of routine 200 are applied to the document 113. Generally described, routine 200 may obtain the document 113 in operation 202 and render the document in operation 204. In operation 206, the width of the table 308 may be determined, and at operation 208, the program module 111 may determine at least one dimension of a display area. Then at operation 210, given the current example, the program module 111 may determine that the width of the table 308 is greater than the width of a display area. Then, in operation 212 and operation 214, a second rendering scale may be determined and applied to the table 308 using a wrapper configured to isolate the application of the second rendering scale to the table. FIG. 4 illustrates the resulting output from operation 214. As shown, the table 308 is scaled to a smaller size, such that the table 308 fits within the boundaries of the first column 310. In addition, the table 308 is positioned and sized such that it does not conflict with other elements of the document, such as the text 314.

FIG. 4 also illustrates one possible result that may arise when an element, such as the table 308, is scaled separately from other elements of a document. In this example, since the table 308 is based on one rendering scale, and the other elements are based on another rendering scale, a margin is created between the table 308 and the text 314 positioned in the first column 310. When such a scenario is presented, as described above, operation 216 may be applied to restore the original intent of the document 113. In one example, a negative margin-bottom may be applied to the text 314 positioned in the first column 310 to compensate for the undesirable formatting, such as the margin illustrated in FIG. 4.

FIG. 5 illustrates yet another example of the rendered content 300 that may be generated when operation 216 of routine 200 is applied to the document 113. As can be appreciated, any code for modifying the position of an element of a document may be used. In one illustrative example, parameters of a <margin> may be introduced. In one example, the application of a negative margin-bottom may reposition the text 314 in the first column 310 to a more suitable position relative to the scaled table 308. The example shown in FIG. 5 is one illustration of how a negative margin-bottom may adjust the text 314 in the first column 310. As shown, the margin between the text 314 in the first column 310 and the table 308 is more aligned with the margin shown in the original rendering shown in FIG. 3.

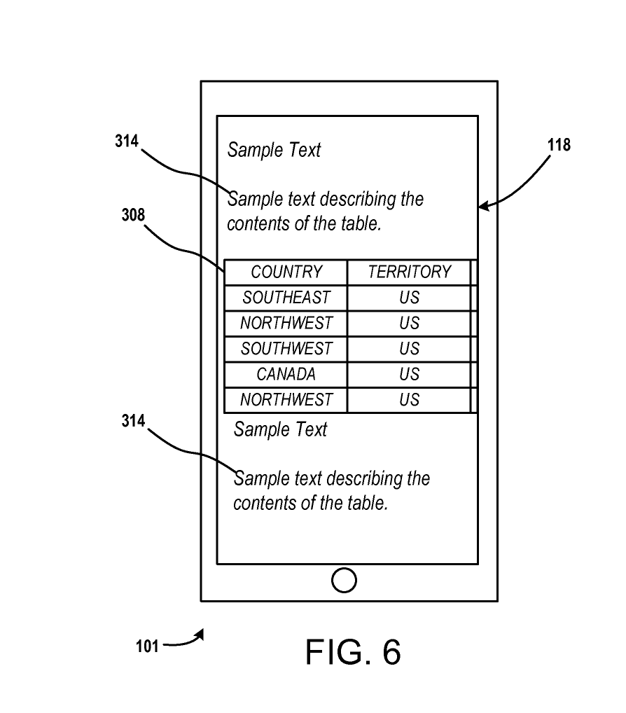

FIGS. 6-7 illustrate other examples of various renderings that show other aspects of the techniques disclosure herein. In one example, consider an element, such as a table, that is configured with a size parameter, such as a table width. If the size parameter of the table is greater than a display area, techniques described herein may wrap the table and apply a second rendering scale to the table to fit the table within the display area. In the example shown in FIGS. 6-7, the display area is defined by hardware parameters, such as a screen size.

FIG. 6 illustrates an example rendering of a document 113 on a display interface 118 of a computing device 101 in the form of a mobile phone. As shown, the document 113 may contain a table 308 and sample text 314. Also shown in FIG. 6, the table 308 is sized such that the width of the table 308 is larger than the width of the display area. In this example, the limitation of the display area is based on the number of pixels of the display interface 118. As can be appreciated, to view the entire table 308, a simple zoom of the entire document may be used. However, a simple zoom may not be desirable as it may resize the text 314 to a point where it is difficult to read. Specifically, the text 314 may not be legible if it is scaled down in size. As described below, by applying techniques described herein, adjustments may be made to the table 308, such that the table 308 may be scaled using one rending scale, while other elements of the document 113, e.g., the text 314, are scaled using another rendering scale.

FIG. 7 illustrates a resulting display of an output that is generated by applying routine 200 to the document 113 rendered in FIG. 6. As shown, the table 308 that is illustrated in FIG. 6, is scaled using a rendering scale that is independent of the rendering scale of the text 314. Specifically, the table 308 is scaled down in size, while the text 314 is rendered at the original rendering scale. In applying the operations of routine 200, the table 308 may be wrapped to isolate the application of a rendering scale. In addition, a negative margin-bottom may be applied to produce an output having a desirable spacing between the table 308 and the text 314 position below the table 308.

FIG. 8 shows additional details of an example computer architecture 800 for a computer, such as the computing device 101 (FIG. 1), capable of executing the program components described above for providing dynamic adjustment of elements of a document. Thus, the computer architecture 800 illustrated in FIG. 8 illustrates an architecture for a server computer, mobile phone, a PDA, a smart phone, a desktop computer, a netbook computer, a tablet computer, and/or a laptop computer. The computer architecture 800 may be utilized to execute any aspects of the software components presented herein.

The computer architecture 800 illustrated in FIG. 8 includes a central processing unit 802 (“CPU”), a system memory 804, including a random access memory 806 (“RAM”) and a read-only memory (“ROM”) 808, and a system bus 810 that couples the memory 804 to the CPU 802. A basic input/output system containing the basic routines that help to transfer information between elements within the computer architecture 800, such as during startup, is stored in the ROM 808. The computer architecture 800 further includes a mass storage device 812 for storing an operating system 807, and one or more application programs including, but not limited to, the web browser 810, program module 111, and a web browser application 810. The illustrated mass storage device 812 may also store a document 113, which may in any format containing any type of information that is accompanied with formatting data.

The mass storage device 812 is connected to the CPU 802 through a mass storage controller (not shown) connected to the bus 810. The mass storage device 812 and its associated computer-readable media provide non-volatile storage for the computer architecture 800. Although the description of computer-readable media contained herein refers to a mass storage device, such as a solid state drive, a hard disk or CD-ROM drive, it should be appreciated by those skilled in the art that computer-readable media can be any available computer storage media or communication media that can be accessed by the computer architecture 800.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 800. For purposes the claims, the phrase “computer storage medium,” “computer-readable storage medium” and variations thereof, does not include waves, signals, and/or other transitory and/or intangible communication media, per se.

According to various configurations, the computer architecture 800 may operate in a networked environment using logical connections to remote computers through the network 1056 and/or another network (not shown). The computer architecture 800 may connect to the network 1056 through a network interface unit 814 connected to the bus 810. It should be appreciated that the network interface unit 814 also may be utilized to connect to other types of networks and remote computer systems. The computer architecture 800 also may include an input/output controller 816 for receiving and processing input from a number of other devices, including a keyboard, mouse, or electronic stylus (not shown in FIG. 8). Similarly, the input/output controller 816 may provide output to a display screen, a printer, or other type of output device (also not shown in FIG. 8).

It should be appreciated that the software components described herein may, when loaded into the CPU 802 and executed, transform the CPU 802 and the overall computer architecture 800 from a general-purpose computing system into a special-purpose computing system customized to facilitate the functionality presented herein. The CPU 802 may be constructed from any number of transistors or other discrete circuit elements, which may individually or collectively assume any number of states. More specifically, the CPU 802 may operate as a finite-state machine, in response to executable instructions contained within the software modules disclosed herein. These computer-executable instructions may transform the CPU 802 by specifying how the CPU 802 transitions between states, thereby transforming the transistors or other discrete hardware elements constituting the CPU 802.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 800 in order to store and execute the software components presented herein. It also should be appreciated that the computer architecture 800 may include other types of computing devices, including hand-held computers, embedded computer systems, personal digital assistants, and other types of computing devices known to those skilled in the art. It is also contemplated that the computer architecture 800 may not include all of the components shown in FIG. 8, may include other components that are not explicitly shown in FIG. 8, or may utilize an architecture completely different than that shown in FIG. 8.

FIG. 9 depicts an illustrative distributed computing environment 900 capable of executing the software components described herein for providing dynamic adjustment of elements of a document, among other aspects. Thus, the distributed computing environment 900 illustrated in FIG. 9 can be utilized to execute any aspects of the software components presented herein. For example, the distributed computing environment 900 can be utilized to execute aspects of the web browser 810, the program module 111 and/or other software components described herein.

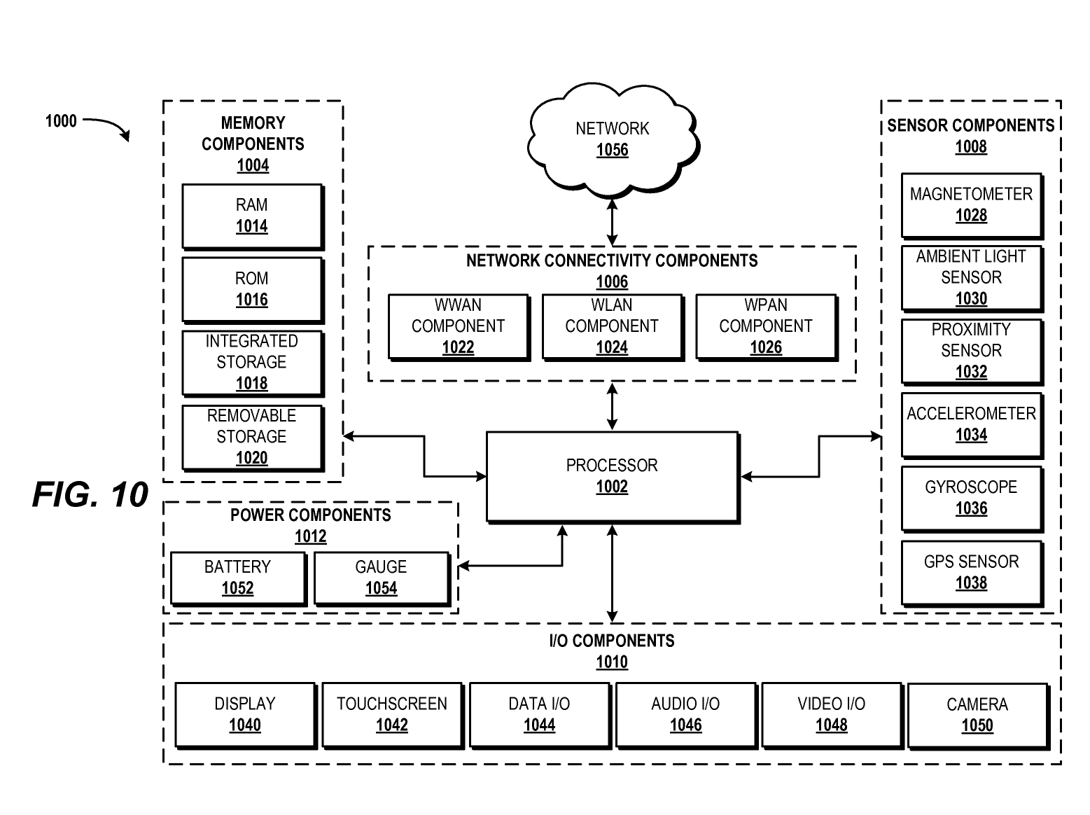

According to various implementations, the distributed computing environment 900 includes a computing environment 902 operating on, in communication with, or as part of the network 904. The network 904 may be or may include the network 1056, described above with reference to FIG. 8. The network 904 also can include various access networks. One or more client devices 906A-906N (hereinafter referred to collectively and/or generically as “clients 906”) can communicate with the computing environment 902 via the network 904 and/or other connections (not illustrated in FIG. 9). In one illustrated configuration, the clients 906 include a computing device 906A such as a laptop computer, a desktop computer, or other computing device; a slate or tablet computing device (“tablet computing device”) 906B; a mobile computing device 906C such as a mobile telephone, a smart phone, or other mobile computing device; a server computer 906D; and/or other devices 906N. It should be understood that any number of clients 906 can communicate with the computing environment 902. Two example computing architectures for the clients 906 are illustrated and described herein with reference to FIGS. 8 and 10. It should be understood that the illustrated clients 906 and computing architectures illustrated and described herein are illustrative, and should not be construed as being limited in any way.

In the illustrated configuration, the computing environment 902 includes application servers 908, data storage 910, and one or more network interfaces 912. According to various implementations, the functionality of the application servers 908 can be provided by one or more server computers that are executing as part of, or in communication with, the network 904. The application servers 908 can host various services, virtual machines, portals, and/or other resources. In the illustrated configuration, the application servers 908 host one or more virtual machines 914 for hosting applications or other functionality. According to various implementations, the virtual machines 914 host one or more applications and/or software modules for providing dynamic adjustment of elements of a document. It should be understood that this configuration is illustrative, and should not be construed as being limiting in any way. The application servers 908 also host or provide access to one or more portals, link pages, Web sites, and/or other information (“Web portals”) 916.

According to various implementations, the application servers 908 also include one or more mailbox services 918 and one or more messaging services 920. The mailbox services 918 can include electronic mail (“email”) services. The mailbox services 918 also can include various personal information management (“PIM”) services including, but not limited to, calendar services, contact management services, collaboration services, and/or other services. The messaging services 920 can include, but are not limited to, instant messaging services, chat services, forum services, and/or other communication services.

The application servers 908 also may include one or more social networking services 922. The social networking services 922 can include various social networking services including, but not limited to, services for sharing or posting status updates, instant messages, links, photos, videos, and/or other information; services for commenting or displaying interest in articles, products, blogs, or other resources; and/or other services. In some configurations, the social networking services 922 are provided by or include the FACEBOOK social networking service, the LINKEDIN professional networking service, the MYSPACE social networking service, the FOURSQUARE geographic networking service, the YAMMER office colleague networking service, and the like. In other configurations, the social networking services 922 are provided by other services, sites, and/or providers that may or may not be explicitly known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Wash. Other services are possible and are contemplated.

The social networking services 922 also can include commenting, blogging, and/or micro blogging services. Examples of such services include, but are not limited to, the YELP commenting service, the KUDZU review service, the OFFICETALK enterprise micro blogging service, the TWITTER messaging service, the GOOGLE BUZZ service, and/or other services. It should be appreciated that the above lists of services are not exhaustive and that numerous additional and/or alternative social networking services 922 are not mentioned herein for the sake of brevity. As such, the above configurations are illustrative, and should not be construed as being limited in any way. According to various implementations, the social networking services 922 may host one or more applications and/or software modules for providing the functionality described herein for providing dynamic adjustment of elements of a document. For instance, any one of the application servers 908 may communicate or facilitate the functionality and features described herein. For instance, a social networking application, mail client, messaging client or a browser running on a phone or any other client 906 may communicate with a networking service 922 and facilitate the functionality, even in part, described above with respect to FIG. 2.

As shown in FIG. 9, the application servers 908 also can host other services, applications, portals, and/or other resources (“other resources”) 924. The other resources 924 can include, but are not limited to, document sharing, rendering or any other functionality. It thus can be appreciated that the computing environment 902 can provide integration of the concepts and technologies disclosed herein provided herein with various mailbox, messaging, social networking, and/or other services or resources.

As mentioned above, the computing environment 902 can include the data storage 910. According to various implementations, the functionality of the data storage 910 is provided by one or more databases operating on, or in communication with, the network 904. The functionality of the data storage 910 also can be provided by one or more server computers configured to host data for the computing environment 902. The data storage 910 can include, host, or provide one or more real or virtual datastores 926A-926N (hereinafter referred to collectively and/or generically as “datastores 926”). The datastores 926 are configured to host data used or created by the application servers 908 and/or other data. Although not illustrated in FIG. 9, the datastores 926 also can host or store web page documents, word documents, spreadsheet documents, data structures, algorithms for execution by a recommendation engine, and/or other data utilized by any application program or another module, such as the program module 111. Aspects of the datastores 926 may be associated with a service for storing files.

The computing environment 902 can communicate with, or be accessed by, the network interfaces 912. The network interfaces 912 can include various types of network hardware and software for supporting communications between two or more computing devices including, but not limited to, the clients 906 and the application servers 908. It should be appreciated that the network interfaces 912 also may be utilized to connect to other types of networks and/or computer systems.

It should be understood that the distributed computing environment 900 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 900 provides the software functionality described herein as a service to the clients 906. It should be understood that the clients 906 can include real or virtual machines including, but not limited to, server computers, web servers, personal computers, mobile computing devices, smart phones, and/or other devices. As such, various configurations of the concepts and technologies disclosed herein enable any device configured to access the distributed computing environment 900 to utilize the functionality described herein for providing dynamic adjustment of elements of a document, among other aspects. In one specific example, as summarized above, techniques described herein may be implemented, at least in part, by the web browser application 810 of FIG. 8, which works in conjunction with the application servers 908 of FIG. 9.

Turning now to FIG. 10, an illustrative computing device architecture 1000 for a computing device that is capable of executing various software components described herein for providing dynamic adjustment of elements of a document. The computing device architecture 1000 is applicable to computing devices that facilitate mobile computing due, in part, to form factor, wireless connectivity, and/or battery-powered operation. In some configurations, the computing devices include, but are not limited to, mobile telephones, tablet devices, slate devices, portable video game devices, and the like. The computing device architecture 1000 is applicable to any of the clients 906 shown in FIG. 9. Moreover, aspects of the computing device architecture 1000 may be applicable to traditional desktop computers, portable computers (e.g., laptops, notebooks, ultra-portables, and netbooks), server computers, and other computer systems, such as described herein with reference to FIG. 8. For example, the single touch and multi-touch aspects disclosed herein below may be applied to desktop computers that utilize a touchscreen or some other touch-enabled device, such as a touch-enabled track pad or touch-enabled mouse.

The computing device architecture 1000 illustrated in FIG. 10 includes a processor 1002, memory components 1004, network connectivity components 1006, sensor components 1008, input/output components 1010, and power components 1012. In the illustrated configuration, the processor 1002 is in communication with the memory components 1004, the network connectivity components 1006, the sensor components 1008, the input/output (“I/O”) components 1010, and the power components 1012. Although no connections are shown between the individuals components illustrated in FIG. 10, the components can interact to carry out device functions. In some configurations, the components are arranged so as to communicate via one or more busses (not shown).

The processor 1002 includes a central processing unit (“CPU”) configured to process data, execute computer-executable instructions of one or more application programs, and communicate with other components of the computing device architecture 1000 in order to perform various functionality described herein. The processor 1002 may be utilized to execute aspects of the software components presented herein and, particularly, those that utilize, at least in part, a touch-enabled input.

In some configurations, the processor 1002 includes a graphics processing unit (“GPU”) configured to accelerate operations performed by the CPU, including, but not limited to, operations performed by executing general-purpose scientific and/or engineering computing applications, as well as graphics-intensive computing applications such as high resolution video (e.g., 720P, 1080P, and higher resolution), video games, three-dimensional (“3D”) modeling applications, and the like. In some configurations, the processor 1002 is configured to communicate with a discrete GPU (not shown). In any case, the CPU and GPU may be configured in accordance with a co-processing CPU/GPU computing model, wherein the sequential part of an application executes on the CPU and the computationally-intensive part is accelerated by the GPU.

In some configurations, the processor 1002 is, or is included in, a system-on-chip (“SoC”) along with one or more of the other components described herein below. For example, the SoC may include the processor 1002, a GPU, one or more of the network connectivity components 1006, and one or more of the sensor components 1008. In some configurations, the processor 1002 is fabricated, in part, utilizing a package-on-package (“PoP”) integrated circuit packaging technique. The processor 1002 may be a single core or multi-core processor.

The processor 1002 may be created in accordance with an ARM architecture, available for license from ARM HOLDINGS of Cambridge, United Kingdom. Alternatively, the processor 1002 may be created in accordance with an x86 architecture, such as is available from INTEL CORPORATION of Mountain View, Calif. and others. In some configurations, the processor 1002 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 1004 include a random access memory (“RAM”) 1014, a read-only memory (“ROM”) 1016, an integrated storage memory (“integrated storage”) 1018, and a removable storage memory (“removable storage”) 1020. In some configurations, the RAM 1014 or a portion thereof, the ROM 1016 or a portion thereof, and/or some combination the RAM 1014 and the ROM 1016 is integrated in the processor 1002. In some configurations, the ROM 1016 is configured to store a firmware, an operating system or a portion thereof (e.g., operating system kernel), and/or a bootloader to load an operating system kernel from the integrated storage 1018 and/or the removable storage 1020.

The integrated storage 1018 can include a solid-state memory, a hard disk, or a combination of solid-state memory and a hard disk. The integrated storage 1018 may be soldered or otherwise connected to a logic board upon which the processor 1002 and other components described herein also may be connected. As such, the integrated storage 1018 is integrated in the computing device. The integrated storage 1018 is configured to store an operating system or portions thereof, application programs, data, and other software components described herein.

The removable storage 1020 can include a solid-state memory, a hard disk, or a combination of solid-state memory and a hard disk. In some configurations, the removable storage 1020 is provided in lieu of the integrated storage 1018. In other configurations, the removable storage 1020 is provided as additional optional storage. In some configurations, the removable storage 1020 is logically combined with the integrated storage 1018 such that the total available storage is made available as a total combined storage capacity. In some configurations, the total combined capacity of the integrated storage 1018 and the removable storage 1020 is shown to a user instead of separate storage capacities for the integrated storage 1018 and the removable storage 1020.

The removable storage 1020 is configured to be inserted into a removable storage memory slot (not shown) or other mechanism by which the removable storage 1020 is inserted and secured to facilitate a connection over which the removable storage 1020 can communicate with other components of the computing device, such as the processor 1002. The removable storage 1020 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 1004 can store an operating system. According to various configurations, the operating system includes, but is not limited to WINDOWS MOBILE OS from Microsoft Corporation of Redmond, Wash., WINDOWS PHONE OS from Microsoft Corporation, WINDOWS from Microsoft Corporation, PALM WEBOS from Hewlett-Packard Company of Palo Alto, Calif., BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The network connectivity components 1006 include a wireless wide area network component (“WWAN component”) 1022, a wireless local area network component (“WLAN component”) 1024, and a wireless personal area network component (“WPAN component”) 1026. The network connectivity components 1006 facilitate communications to and from the network 1056 or another network, which may be a WWAN, a WLAN, or a WPAN. Although only the network 1056 is illustrated, the network connectivity components 1006 may facilitate simultaneous communication with multiple networks, including the network 904 of FIG. 9. For example, the network connectivity components 1006 may facilitate simultaneous communications with multiple networks via one or more of a WWAN, a WLAN, or a WPAN.

The network 1056 may be or may include a WWAN, such as a mobile telecommunications network utilizing one or more mobile telecommunications technologies to provide voice and/or data services to a computing device utilizing the computing device architecture 1000 via the WWAN component 1022. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”). Moreover, the network 1056 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 104 may be configured to provide voice and/or data communications with any combination of the above technologies. The network 1056 may be configured to or adapted to provide voice and/or data communications in accordance with future generation technologies.

In some configurations, the WWAN component 1022 is configured to provide dual- multi-mode connectivity to the network 1056. For example, the WWAN component 1022 may be configured to provide connectivity to the network 1056, wherein the network 1056 provides service via GSM and UMTS technologies, or via some other combination of technologies. Alternatively, multiple WWAN components 1022 may be utilized to perform such functionality, and/or provide additional functionality to support other non-compatible technologies (i.e., incapable of being supported by a single WWAN component). The WWAN component 1022 may facilitate similar connectivity to multiple networks (e.g., a UMTS network and an LTE network).

The network 1056 may be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 1024 is configured to connect to the network 1056 via the WI-FI access points. Such connections may be secured via various encryption technologies including, but not limited, WI-FI Protected Access (“WPA”), WPA2, Wired Equivalent Privacy (“WEP”), and the like.

The network 1056 may be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 1026 is configured to facilitate communications with other devices, such as peripherals, computers, or other computing devices via the WPAN.

The sensor components 1008 include a magnetometer 1028, an ambient light sensor 1030, a proximity sensor 1032, an accelerometer 1034, a gyroscope 1036, and a Global Positioning System sensor (“GPS sensor”) 1038. It is contemplated that other sensors, such as, but not limited to, temperature sensors or shock detection sensors, also may be incorporated in the computing device architecture 1000.

The magnetometer 1028 is configured to measure the strength and direction of a magnetic field. In some configurations the magnetometer 1028 provides measurements to a compass application program stored within one of the memory components 1004 in order to provide a user with accurate directions in a frame of reference including the cardinal directions, north, south, east, and west. Similar measurements may be provided to a navigation application program that includes a compass component. Other uses of measurements obtained by the magnetometer 1028 are contemplated.

The ambient light sensor 1030 is configured to measure ambient light. In some configurations, the ambient light sensor 1030 provides measurements to an application program stored within one the memory components 1004 in order to automatically adjust the brightness of a display (described below) to compensate for low-light and high-light environments. Other uses of measurements obtained by the ambient light sensor 1030 are contemplated.

The proximity sensor 1032 is configured to detect the presence of an object or thing in proximity to the computing device without direct contact. In some configurations, the proximity sensor 1032 detects the presence of a user's body (e.g., the user's face) and provides this information to an application program stored within one of the memory components 1004 that utilizes the proximity information to enable or disable some functionality of the computing device. For example, a telephone application program may automatically disable a touchscreen (described below) in response to receiving the proximity information so that the user's face does not inadvertently end a call or enable/disable other functionality within the telephone application program during the call. Other uses of proximity as detected by the proximity sensor 1032 are contemplated.

The accelerometer 1034 is configured to measure proper acceleration. In some configurations, output from the accelerometer 1034 is used by an application program as an input mechanism to control some functionality of the application program. For example, the application program may be a video game in which a character, a portion thereof, or an object is moved or otherwise manipulated in response to input received via the accelerometer 1034. In some configurations, output from the accelerometer 1034 is provided to an application program for use in switching between landscape and portrait modes, calculating coordinate acceleration, or detecting a fall. Other uses of the accelerometer 1034 are contemplated.

The gyroscope 1036 is configured to measure and maintain orientation. In some configurations, output from the gyroscope 1036 is used by an application program as an input mechanism to control some functionality of the application program. For example, the gyroscope 1036 can be used for accurate recognition of movement within a 3D environment of a video game application or some other application. In some configurations, an application program utilizes output from the gyroscope 1036 and the accelerometer 1034 to enhance control of some functionality of the application program. Other uses of the gyroscope 1036 are contemplated.

The GPS sensor 1038 is configured to receive signals from GPS satellites for use in calculating a location. The location calculated by the GPS sensor 1038 may be used by any application program that requires or benefits from location information. For example, the location calculated by the GPS sensor 1038 may be used with a navigation application program to provide directions from the location to a destination or directions from the destination to the location. Moreover, the GPS sensor 1038 may be used to provide location information to an external location-based service, such as E911 service. The GPS sensor 1038 may obtain location information generated via WI-FI, WIMAX, and/or cellular triangulation techniques utilizing one or more of the network connectivity components 1006 to aid the GPS sensor 1038 in obtaining a location fix. The GPS sensor 1038 may also be used in Assisted GPS (“A-GPS”) systems.

The I/O components 1010 include a display 1040, a touchscreen 1042, a data I/O interface component (“data I/O”) 1044, an audio I/O interface component (“audio I/O”) 1046, a video I/O interface component (“video I/O”) 1048, and a camera 1050. In some configurations, the display 1040 and the touchscreen 1042 are combined. In some configurations two or more of the data I/O component 1044, the audio I/O component 1046, and the video I/O component 1048 are combined. The I/O components 1010 may include discrete processors configured to support the various interface described below, or may include processing functionality built-in to the processor 1002.

The display 1040 is an output device configured to present information in a visual form. In particular, the display 1040 may present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display 1040 is a liquid crystal display (“LCD”) utilizing any active or passive matrix technology and any backlighting technology (if used). In some configurations, the display 1040 is an organic light emitting diode (“OLED”) display. Other display types are contemplated.

The touchscreen 1042, also referred to herein as a “touch-enabled screen,” is an input device configured to detect the presence and location of a touch. The touchscreen 1042 may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some configurations, the touchscreen 1042 is incorporated on top of the display 1040 as a transparent layer to enable a user to use one or more touches to interact with objects or other information presented on the display 1040. In other configurations, the touchscreen 1042 is a touch pad incorporated on a surface of the computing device that does not include the display 1040. For example, the computing device may have a touchscreen incorporated on top of the display 1040 and a touch pad on a surface opposite the display 1040.

In some configurations, the touchscreen 1042 is a single-touch touchscreen. In other configurations, the touchscreen 1042 is a multi-touch touchscreen. In some configurations, the touchscreen 1042 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen 1042. As such, a developer may create gestures that are specific to a particular application program.

In some configurations, the touchscreen 1042 supports a tap gesture in which a user taps the touchscreen 1042 once on an item presented on the display 1040. The tap gesture may be used for various reasons including, but not limited to, opening or launching whatever the user taps. In some configurations, the touchscreen 1042 supports a double tap gesture in which a user taps the touchscreen 1042 twice on an item presented on the display 1040. The double tap gesture may be used for various reasons including, but not limited to, zooming in or zooming out in stages. In some configurations, the touchscreen 1042 supports a tap and hold gesture in which a user taps the touchscreen 1042 and maintains contact for at least a pre-defined time.

The tap and hold gesture may be used for various reasons including, but not limited to, opening a context-specific menu.

In some configurations, the touchscreen 1042 supports a pan gesture in which a user places a finger on the touchscreen 1042 and maintains contact with the touchscreen 1042 while moving the finger on the touchscreen 1042. The pan gesture may be used for various reasons including, but not limited to, moving through screens, images, or menus at a controlled rate. Multiple finger pan gestures are also contemplated. In some configurations, the touchscreen 1042 supports a flick gesture in which a user swipes a finger in the direction the user wants the screen to move. The flick gesture may be used for various reasons including, but not limited to, scrolling horizontally or vertically through menus or pages. In some configurations, the touchscreen 1042 supports a pinch and stretch gesture in which a user makes a pinching motion with two fingers (e.g., thumb and forefinger) on the touchscreen 1042 or moves the two fingers apart. The pinch and stretch gesture may be used for various reasons including, but not limited to, zooming gradually in or out of a website, map, or picture.

Although the above gestures have been described with reference to the use one or more fingers for performing the gestures, other appendages such as toes or objects such as styluses may be used to interact with the touchscreen 1042. As such, the above gestures should be understood as being illustrative and should not be construed as being limiting in any way.

The data I/O interface component 1044 is configured to facilitate input of data to the computing device and output of data from the computing device. In some configurations, the data I/O interface component 1044 includes a connector configured to provide wired connectivity between the computing device and a computer system, for example, for synchronization operation purposes. The connector may be a proprietary connector or a standardized connector such as USB, micro-USB, mini-USB, or the like. In some configurations, the connector is a dock connector for docking the computing device with another device such as a docking station, audio device (e.g., a digital music player), or video device.

The audio I/O interface component 1046 is configured to provide audio input and/or output capabilities to the computing device. In some configurations, the audio I/O interface component 1046 includes a microphone configured to collect audio signals. In some configurations, the audio I/O interface component 1046 includes a headphone jack configured to provide connectivity for headphones or other external speakers. In some configurations, the audio I/O interface component 1046 includes a speaker for the output of audio signals. In some configurations, the audio I/O interface component 1046 includes an optical audio cable out.

The video I/O interface component 1048 is configured to provide video input and/or output capabilities to the computing device. In some configurations, the video I/O interface component 1048 includes a video connector configured to receive video as input from another device (e.g., a video media player such as a DVD or BLURAY player) or send video as output to another device (e.g., a monitor, a television, or some other external display). In some configurations, the video I/O interface component 1048 includes a High-Definition Multimedia Interface (“HDMI”), mini-HDMI, micro-HDMI, DisplayPort, or proprietary connector to input/output video content. In some configurations, the video I/O interface component 1048 or portions thereof is combined with the audio I/O interface component 1046 or portions thereof.

The camera 1050 can be configured to capture still images and/or video. The camera 1050 may utilize a charge coupled device (“CCD”) or a complementary metal oxide semiconductor (“CMOS”) image sensor to capture images. In some configurations, the camera 1050 includes a flash to aid in taking pictures in low-light environments. Settings for the camera 1050 may be implemented as hardware or software buttons.

Although not illustrated, one or more hardware buttons may also be included in the computing device architecture 1000. The hardware buttons may be used for controlling some operational aspect of the computing device. The hardware buttons may be dedicated buttons or multi-use buttons. The hardware buttons may be mechanical or sensor-based.

The illustrated power components 1012 include one or more batteries 1052, which can be connected to a battery gauge 1054. The batteries 1052 may be rechargeable or disposable. Rechargeable battery types include, but are not limited to, lithium polymer, lithium ion, nickel cadmium, and nickel metal hydride. Each of the batteries 1052 may be made of one or more cells.

The battery gauge 1054 can be configured to measure battery parameters such as current, voltage, and temperature. In some configurations, the battery gauge 1054 is configured to measure the effect of a battery's discharge rate, temperature, age and other factors to predict remaining life within a certain percentage of error. In some configurations, the battery gauge 1054 provides measurements to an application program that is configured to utilize the measurements to present useful power management data to a user. Power management data may include one or more of a percentage of battery used, a percentage of battery remaining, a battery condition, a remaining time, a remaining capacity (e.g., in watt hours), a current draw, and a voltage.

The power components 1012 may also include a power connector, which may be combined with one or more of the aforementioned I/O components 1010. The power components 1012 may interface with an external power system or charging equipment via an I/O component.

The disclosure presented herein may be considered in view of the following clauses.

Clause 1: A computer-implemented example for rendering a document including an element, the example including: rendering, at a computing device (1000), the document (113) at a first rendering scale; determining, at the computing device (1000), a dimension of the element (308) based on the rendering of the document (113); determining if the dimension of the element (308) is greater than a dimension of a display area (310, 118); if the dimension of the element (308) is greater than the dimension of the display area (310, 118), determining a second rendering scale based on the dimension of the display area (310, 118), wrapping the element (308) to contain the second rendering scale to the element (308), and applying the second rendering scale to the element (308).

Clause 2: The example of clause 1, further comprising rendering an output including data defining the second rendering scale, the element and other elements of the document, wherein the element is rendered at the second rendering scale and the other elements of the document are rendered at the first rendering scale.

Clause 3: The example of clauses 1-2, wherein the document contains at least one other element, and wherein the method further comprises applying a position adjustment to the at least one other element, wherein the position adjustment changes a position of the at least one other element relative to the element.

Clause 4: The example of clauses 1-3, wherein the margin adjustment includes a negative margin-bottom configured to reposition the at least one other element closer to the element.

Clause 5: The example of clauses 1-4, wherein the document defines the dimension of the display area.

Clause 6: The example of clauses 1-5, wherein data describing a display capability of a display device defines the dimension of the display area.

Clause 7: The example of clauses 1-6, wherein the element is a table associated with data defining a width of the table, wherein the dimension of the element is the width of the table, wherein the display area is a column associated with data defining a width of the column, and wherein the dimension of the display area is the width of the column.

Clause 8: A computer-implemented example for rendering a document (113) including a table (308), the example including: rendering, at a computing device (1000), the document (113) at a first rendering scale; determining, at the computing device (1000), a width of the table (308) based on the rendering of the document (113); determining, at the computing device (1000), if the width of the table (308) is greater than a width of a display area (310, 118); if the width of the table (308) is greater than the width of the display area (310, 118), determining a second rendering scale based on the width of the display area (310, 118), wrapping the table (308) to contain the second rendering scale to the table (308), and applying the second rendering scale to the table (308).

Clause 9: The example of clause 8, further comprising rendering an output including data defining the second rendering scale, the table and other elements of the document, wherein the table is rendered at the second rendering scale and the other elements of the document are rendered at the first rendering scale.

Clause 10: The example of clauses 8-9, wherein the document contains at least one other element, wherein the method further comprises applying a position adjustment to the table or to at least one other element, and wherein the position adjustment changes a position of the table or to the at least one other element.

Clause 11: The example of clauses 8-10, wherein the adjustment includes a negative margin-bottom configured to reposition the at least one other element closer to the table.

Clause 12: The example of clauses 8-11, wherein the document defines the dimension of the display area.

Clause 13: The example of clauses 8-12, wherein data describing a display capability of a display device defines the dimension of the display area.

Clause 14: The example of clauses 8-13, wherein the width of the table is determined by: retrieving coordinates from one or more software modules; and determining the width of the table based on the coordinates.

Clause 15: An example computer (1000), including: a processor (1002); and a computer-readable storage medium (1004) in communication with the processor (1002), the computer-readable storage medium (1004) having computer-executable instructions stored thereupon which, when executed by the processor (1002), cause the computer (1000) to render the document at a first rendering scale, determine a width of the table (308) based on the rendering of the document (113), determine if the width of the table (308) is greater than a width of a display area (310, 118), if the width of the table (308) is greater than the width of the display area (310, 118), determine a second rendering scale based on the width of the display area (310, 118), wrap the table (308) to apply the second rendering scale to the table (308), and apply the second rendering scale to the table (308).

Clause 16: The example computer of clause 15, wherein the computer-readable storage medium has further computer-executable instructions stored thereupon, which when executed by the processor, cause the computer to render an output including data defining the second rendering scale, the table and other elements of the document, wherein the table is rendered at the second rendering scale and the other elements of the document are rendered at the first rendering scale.

Clause 17: The example computer of clauses 15 and 16, wherein the document contains at least one other element, and wherein the computer-readable storage medium has further computer-executable instructions stored thereupon, which when executed by the processor, cause the computer to apply a margin adjustment to the at least one other element, wherein the margin adjustment changes a position of the at least one other element relative to the table.

Clause 18: The example computer of clauses 15-17, wherein the margin adjustment includes a negative margin-bottom configured to reposition the at least one other element closer to the table.

Clause 19: The example computer of clauses 15-18, wherein the document defines the dimension of the display area.

Clause 20: The example computer of clauses 15-19, wherein data describing a display capability of a display device defines the dimension of the display area.

Based on the foregoing, it should be appreciated that concepts and technologies have been disclosed herein that provide dynamic adjustment of elements of a document. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example configurations and applications illustrated and described, and without departing from the true spirit and scope of the present invention, which is set forth in the following claims.

What is claimed is:

1. A computer-implemented method for rendering a document including an element, the method comprising:
rendering, at a computing device, the document at a first rendering scale;
determining, at the computing device, a dimension of the element based on the rendering of the document;
determining if the dimension of the element is greater than a dimension of a display area;
if the dimension of the element is greater than the dimension of the display area,
determining a second rendering scale based on the dimension of the display area,
wrapping the element to contain the second rendering scale to the element, and
applying the second rendering scale to the element.

2. The computer-implemented method of claim 1, further comprising rendering an output including data defining the second rendering scale, the element and other elements of the document, wherein the element is rendered at the second rendering scale and the other elements of the document are rendered at the first rendering scale.

3. The computer-implemented method of claim 1, wherein the document contains at least one other element, and wherein the method further comprises applying a position adjustment to the at least one other element, wherein the position adjustment changes a position of the at least one other element relative to the element.

4. The computer-implemented method of claim 3, wherein the margin adjustment includes a negative margin-bottom configured to reposition the at least one other element closer to the element.

5. The computer-implemented method of claim 1, wherein the document defines the dimension of the display area.

6. The computer-implemented method of claim 1, wherein data describing a display capability of a display device defines the dimension of the display area.

7. The computer-implemented method of claim 1, wherein the element is a table associated with data defining a width of the table, wherein the dimension of the element is the width of the table, wherein the display area is a column associated with data defining a width of the column, and wherein the dimension of the display area is the width of the column.

8. A computer-implemented method for rendering a document including a table, the method comprising:
rendering, at a computing device, the document at a first rendering scale;
determining, at the computing device, a width of the table based on the rendering of the document;
determining, at the computing device, if the width of the table is greater than a width of a display area;
if the width of the table is greater than the width of the display area,
determining a second rendering scale based on the width of the display area,
wrapping the table to contain the second rendering scale to the table, and
applying the second rendering scale to the table.

9. The computer-implemented method of claim 8, further comprising rendering an output including data defining the second rendering scale, the table and other elements of the document, wherein the table is rendered at the second rendering scale and the other elements of the document are rendered at the first rendering scale.

10. The computer-implemented method of claim 8, wherein the document contains at least one other element, wherein the method further comprises applying a position adjustment to the table or to at least one other element, and wherein the position adjustment changes a position of the table or to the at least one other element.

11. The computer-implemented method of claim 10, wherein the adjustment includes a negative margin-bottom configured to reposition the at least one other element closer to the table.

12. The computer-implemented method of claim 8, wherein the document defines the dimension of the display area.

13. The computer-implemented method of claim 8, wherein data describing a display capability of a display device defines the dimension of the display area.

14. The computer-implemented method of claim 8, wherein the width of the table is determined by:
retrieving coordinates from one or more software modules; and
determining the width of the table based on the coordinates.

15. A computer, comprising:
a processor; and
a computer-readable storage medium in communication with the processor, the computer-readable storage medium having computer-executable instructions stored thereupon which, when executed by the processor, cause the computer to
render the document at a first rendering scale,
determine a width of the table based on the rendering of the document,
determine if the width of the table is greater than a width of a display area,
if the width of the table is greater than the width of the display area,
determine a second rendering scale based on the width of the display area,
wrap the table to apply the second rendering scale to the table, and
apply the second rendering scale to the table.

16. The computer of claim 15, wherein the computer-readable storage medium has further computer-executable instructions stored thereupon, which when executed by the processor, cause the computer to render an output including data defining the second rendering scale, the table and other elements of the document, wherein the table is rendered at the second rendering scale and the other elements of the document are rendered at the first rendering scale.

17. The computer of claim 15, wherein the document contains at least one other element, and wherein the computer-readable storage medium has further computer-executable instructions stored thereupon, which when executed by the processor, cause the computer to apply a margin adjustment to the at least one other element, wherein the margin adjustment changes a position of the at least one other element relative to the table.

18. The computer of claim 17, wherein the margin adjustment includes a negative margin-bottom configured to reposition the at least one other element closer to the table.

19. The computer of claim 15, wherein the document defines the dimension of the display area.

20. The computer of claim 15, wherein data describing a display capability of a display device defines the dimension of the display area.
